(19) United States
(12) Patent Application Publication
(10) Pub. No.: US 2020/0196647 A1
(43) Pub. Date: Jun. 25, 2020

(54) REMEDY FOR HANGOVER

(71) Applicant: IcySpicy.com LLC, Manchester, CT (US)

(72) Inventor: Hetal Patel, South Windsor, CT (US)

(21) Appl. No.: 16/726,146

(22) Filed: Dec. 23, 2019

Related U.S. Application Data
(60) Provisional application No. 62/784,624, filed on Dec. 24, 2018.

(51) Int. Cl. A23L 27/12; A23L 19/00; A23L 33/00

(52) U.S. Cl. CPC A23L 27/12; A23L 33/30; A23L 19/01

(57) ABSTRACT

According to some embodiments, an organic remedy for relief from a hangover is disclosed. The hangover remedy is in a form of an organic dietary health supplement. The hangover remedy comprises between 90% and 98% class A ingredients, between 1% and 5% class B ingredients, and between 1% and 5% class C ingredients.

### BACKGROUND

A hangover is the experience of various unpleasant physiological and psychological effects following the consumption of alcohol, such as wine, beer and distilled spirits. Hangovers can last for several hours or for more than 24 hours. The more alcohol consumed by a person, the higher will be the chances of developing some or severe effects of Hangover a few hours later or the next day.

Hangovers are generally the result of the unpleasant after effects of consuming ethanol, the main psychoactive ingredient in alcoholic beverages. The unpleasant effects from hangover are generally attributed to a combination of dehydration, toxic impurities found in some alcoholic beverages (congeners), and toxic byproducts of alcohol metabolism.

Ethanol is a diuretic that can suppress the release of antidiuretic hormone from the pituitary gland and result in excess diuresis. Congeners are impure fusel alcohols that are often present in “darker” spirits or red wine and can contribute to hangover symptoms following consumption. Ethanol is metabolized into the toxic metabolite acetaldehyde, which can cause nausea and malaise. Decreased blood sugar and secondary general inflammation from ethanol consumption may also play a role in hangover symptoms.

Hangover symptoms typically begin when your blood alcohol content drops significantly and is at or near zero. They are usually in full effect the morning after a night of heavy drinking. Depending on what and how much a person drank, some of the following undesirable impacts may be felt:
Fatigue and Weakness
Severe Headache
Muscle Aches
Nausea, Vomiting or Stomach Pain
Poor or Decreased Sleep
Increased Sensitivity to Light and Sound
Dizziness
Shakiness
Decreased Ability to Concentrate
Excessive Thirst and Dry Mouth
Mood disturbances such as Depression, Anxiety and Irritability
Rapid Heartbeat

Conventional remedies for hangovers include the following:
NSAIDs (Nonsteroidal Anti-Inflammatory Drugs) such as Aspirin, Ibuprofen and Naproxen.
N-Acetyl L-Cysteine (NAC) Amino Acid
Dihydromyricetin
Activated Charcoal
Combinations of Vitamins, Thiamin, Folic Acid, etc.

However, many of the conventional remedies use chemicals which may not be good for all people experiencing hangovers and, as such, a more organic remedy may be desired.

### BRIEF DESCRIPTION OF THE DRAWINGS

FIG. 1 illustrates a chart according to some embodiments.

FIG. 2 illustrates a chart according to some embodiments.

### DETAILED DESCRIPTION

The present embodiments relate to an organic remedy for relief from a hangover in a form of an organic dietary health supplement that may also have numerous other health benefits. The present embodiments may be comprised of three classes of ingredients as listed below:

A) Class A ingredients

B) Class B ingredients

C) Class C ingredients

The hangover remedy may be in the form of a veggie or gelatin capsules, a sachet packet that may be dissolved in a liquid, and/or a beverage comprising the above ingredients that may be packed in a bottle, can or TetraPak™. The present hangover remedy, taken in suggested dosage, may effectively help in stopping, reducing or relieving effects of Hangover. In some embodiments the suggested dose may comprise 650 Mg. In some embodiments, the hangover remedy may be in the form of a flavored gum-like or chewable substance (e.g., gummies).

Class A ingredients may comprise one or more of a variety of cactus such as, but not limited to Nopal cactus. Nopal cactus is an herb also known as Nopales, Prickly Pear, Indian Fig and Barbary Fig. In some embodiments, the present remedy may be comprised of Nopal with Prickly Pear Fruit Powder manufactured at USFDA registered facility from uniquely sourced large Nopal Pads from very select geographic location that delivers the most nutritionally beneficial especially having properties that helps relieving effects of hangover. Nopal Cactus (Prickly Pear) comprises the following: (1) 18 Amino Acids: Alanine, Arginine, Aspartic Acid, Cystine, Glutamic Acid, Glycine, Histidine, Leucine, Isoleucine, Lysine, Methionine, Phenylalanine, Proline, Serine, Threonine, Tryptophan, Tyrosine and Valine; (2) 15 Potent Phytonutrients; (3) 10 Minerals: Calcium, Copper, Iron, Magnesium, Manganese, Phosphorus, Selenium, Sodium, Zinc; (4) 8 Vitamins: Vitamin A, Thiamin (B1), Riboflavin (B2), Niacin (B3), Pyridoxine (B6), Ascorbic Acid (C), Vitamin E and Folate; (5) Betalains, (6) Fiber and (7) Pectin.

Class B ingredients may comprise one or more of a flowering plant of the ginger family, Zingiberaceae, such as, but not limited to, Turmeric. Turmeric is an herb also known as Curcuma, Curcuma aromatica, Curcuma domestica, Curcumae Longa, Curcumae Longae Rhizoma, Curcumin, Curcumine, Curcuminoids, Halada, Haldi, Haldar, Hardar, Haridra, Indian Saffron, Nisha, Pian Jiang Huang, Racine de Curcuma, Radix Curcumae, Rajani, Rhizoma Cucurmae Longae, Safran Bourbon, Safran de Batallita, Safran des Indes, Turmeric Root and Yu Jin. Turmeric comprises various minerals, vitamins, fiber and phytonutrients.

Class C ingredients may comprise one or more of a flowering plant of the ginger family, Zingiberaceae, such as, but not limited to, Ginger. Ginger is an herb also known as Ginger Root, Adrak, Adu, Amomum Zingiber, Ardraka, Black Ginger, Cochin Ginger, Gan Jiang, Gingembre, Imber, Imibir, Jengibre, Jiang, Kankyo, Kanshokyo, Nagara, Race Ginger, Racine de Gingembre, Rhizoma Zingiberi, Zingiberis Recens, Sauth, Singabera, Sheng Jiang, Shoga, Shokyo, Shunthi, Srungavera, Sunth, Sunthi, Vishvabheshaja, Zanjabil and other names.

Ginger comprises Rhizomes—Carbohydrates, Lipids, Terpenes compounds (Zingiberene, β-Bisabolene, α-Farnesene, β-Sesquiphellandrene, and α-Curcumene), Phenolic compounds (Gingerol, Paradols, and Shogaol). Ginger also comprises some Amino acids, Raw Fiber, Ash, Protein, Phytosterols, Vitamins, Minerals and Flavonoids.

In some embodiments, the remedy described herein comprises between 90% and 98% class A ingredients, between 1% and 5% class B ingredients and between 1% and 5% class C ingredients.

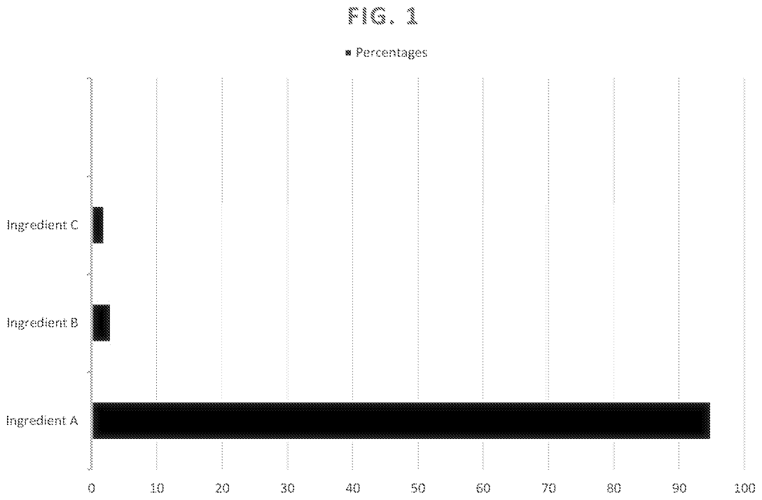

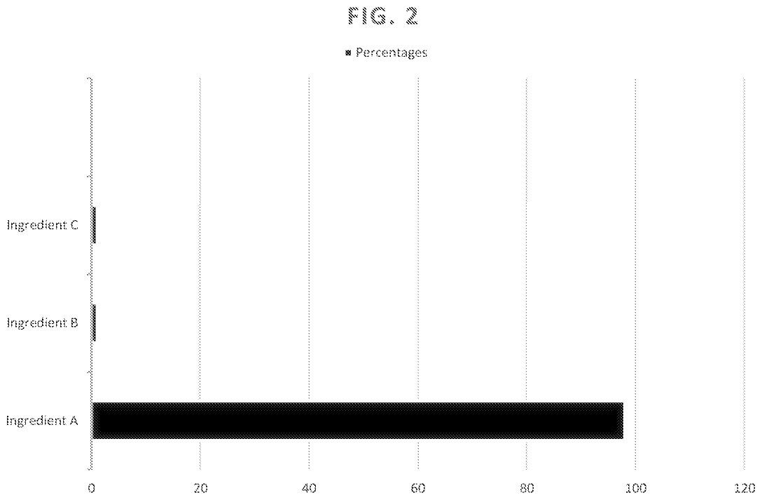

For example, in one embodiment, and as shown in FIG. 1, the remedy comprises 95% Nopal Powder, 3% Turmeric Powder and 2% Ginger Powder. In some embodiments, and as shown in FIG. 2, the remedy comprises 98% Nopal Powder, 1% Turmeric Powder and 1% Ginger Powder. In some embodiments, the remedy may also comprise 95% Nopal Powder, 5% Turmeric Powder and 5% Ginger Powder. In some embodiments, rice hull power may also be added as a moisture absorber.

Those in the art will appreciate that various adaptations and modifications of the above-described embodiments can be configured without departing from the scope and spirit of the claims. Therefore, it is to be understood that the claims may be practiced other than as specifically described herein.

What is claimed:

1. A hangover remedy comprising:
between 90% and 98% class A ingredients;
between 1% and 5% class B ingredients; and
between 1% and 5% class C ingredients.

2. The hangover remedy of claim 1, wherein the class A ingredients comprise Nopal cactus.

3. The hangover remedy for claim 2, wherein the class B ingredients comprise Turmeric.

4. The hangover remedy of claim 3, wherein the class C ingredients comprise Ginger.

5. The hangover remedy of claim 1, wherein the hangover remedy comprises 95% Nopal Powder as the class A ingredients, 3% Turmeric Powder as the class B ingredients and 2% Ginger Powder as the class C ingredients.

6. The hangover remedy of claim 1, further comprising rice hull powder.

7. The hangover remedy of claim 1, wherein the class A ingredients comprise a combination of Nopal cactus and a Prickly Pear Fruit Powder.

8. A hangover remedy comprising:
98% class A ingredients;
1% class B ingredients; and
1% class C ingredients.

9. The hangover remedy of claim 8, wherein the class A ingredients comprise Nopal cactus.

10. The hangover remedy for claim 9, wherein the class B ingredients comprise Turmeric.

11. The hangover remedy of claim 10, wherein the class C ingredients comprise Ginger.

12. A hangover remedy comprising:
90% class A ingredients;
5% class B ingredients; and
5% class C ingredients.

13. The hangover remedy of claim 1, wherein the class A ingredients comprise Nopal cactus.

14. The hangover remedy for claim 2, wherein the class B ingredients comprise Turmeric.

15. The hangover remedy of claim 3, wherein the class C ingredients comprise Ginger.
